(19) United States
(12) Patent Application Publication
(10) Pub. No.: US 2006/0025498 A1
(43) Pub. Date: Feb. 2, 2006

(54) Inkjet ink and image-forming method using the same

(75) Inventors: Yuuichi Fukushige, Shizuoka-ken (JP); Shojiro Sano, Shizuoka-ken (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/185,739

(22) Filed: Jul. 21, 2005

(30) Foreign Application Priority Data
Jul. 27, 2004 (JP) 2004-219205

(51) Int. Cl. C03C 17/00; C09D 11/00

(52) U.S. Cl. 523/160; 523/161

(57) ABSTRACT

An inkjet ink comprising a plurality of liquids containing a polymerizable compound, a polymerization initiator, a colorant, and two compounds which react with each other to form an aggregate or become viscous when mixed with each other. There is no liquid containing both of the compounds capable of reacting with each other. The compounds capable of reacting with each other may be a compound having an acidic moiety and a compound having a basic moiety. Also provided is an image-forming method using the inkjet ink.

### CROSS-REFERENCE TO RELATED APPLICATION

This application claims priority under 35 USC 119 from Japanese patent Application No. 2004-219205, the disclosure of which is incorporated by reference herein.

### BACKGROUND OF THE INVENTION

1. Field of the Invention

The present invention is related to an inkjet ink and an image-forming method using the same. Specifically, the invention is related to an inkjet ink excellent in image reproducibility and an image-forming method using the same. The inkjet ink comprises a plurality of liquids which form an aggregate upon mixing.

2. Description of the Related Art

Inkjet methods have been used in a lot of printers because the method can be conducted with a compact and inexpensive instruments and because images can be formed on recording media in a non-contact manner. In inkjet methods, ink is ejected from an ink-discharging opening. Among inkjet methods, piezo-inkjet methods and thermal-inkjet methods enable high resolution and high speed printing. The piezo-inkjet methods utilize deformation of piezo elements to discharge ink and the thermal-inkjet methods utilize boiling of ink caused by application of thermal energy to discharge ink.

It is an important issue concerning inkjet printers to improve the printing speed and the image quality when the recording medium is a recording medium with a poor water-absorbing property such as plain paper or plastic. When it takes time for the liquid droplets to dry after printing, image bleed easily occurs and neighboring ink droplets mix with each other, thereby inhibiting formation of clear image. Further, the printed sheets cannot be stacked just after printing but have to be dried because of the slow drying rate of the solvent when the printed sheets have a low water-absorbing property. Conventional inkjet methods have had practical problems as described above.

An inkjet ink has been proposed (for example in Japanese Patent Laid-Open (JP-A) No. 5-214279, the disclosure of which is incorporated herein by reference) for suppressing the image bleed and intermixture of ink droplets. The inkjet ink is an ink which is cured and fixed not by evaporation of ink solvent but by radiation, thus facilitating curing of the ink. However, use of a pigment dispersion as the colorant causes aggregation of the pigment in the nozzle to clog the nozzle, whereby stable discharge of the ink is difficult.

As an alternative, a pigment-free UV-curable ink containing a dye as the colorant has been proposed (for example in U.S. Pat. No. 4,303,924, the disclosure of which is incorporated herein by reference) for enabling formation of image excellent in transparency and color tone. This ink is likely to cause undesirable polymerization reaction during storage, whereby the storage stability of the ink is not sufficient. Further, conductive salts contained in the ink occasionally have poor solubility in the ink, whereby precipitation sometimes occurs during long-term storage to cause printing defects.

An ink comprised of two liquids has been proposed for achieving both storage stability and quick drying. The two liquids are allowed to react with each other on a recording medium. For example, JP-A No. 63-60783 (the disclosure of which is incorporated by reference herein) discloses a method in which an ink containing an anionic dye is provided on a recording medium after a liquid containing a basic polymer is provided on the recording medium. Further, JP-A No. 8-174997 (the disclosure of which is incorporated by reference herein) discloses a method in which an ink containing an anionic compound and a colorant is provided on a recording medium after a liquid composition containing a cationic substance is provided on the recording medium. These methods inhibit image bleed by precipitation of the dye. However, these methods do not suppress intermixture of ink droplets, and use of an aqueous solvent decreases the drying speed. Further, the precipitated dye is likely to be unevenly distributed on the recording medium, whereby image quality may be lowered.

### SUMMARY OF THE INVENTION

The inventors of the present invention have conducted intensive research and have found that problems described above can be solved by use of an ink comprising a plurality of liquids containing specific reactive components, thereby making the invention.

An aspect of the invention is to provide an inkjet ink used for formation of an image on a recording medium by discharge of a plurality of liquids. The liquids include liquid(s) each containing a first compound (hereinafter referred to as “a reactive compound (A)”) and liquid(s) each containing a second compound (hereinafter referred to as “a reactive compound (B)”). The reactive compound (A) and the reactive compound (B) can react with each other to form an aggregate or to increase the viscosity of the mixture liquid containing the reactive compounds. However, among the liquids constituting the ink, there is no liquid containing both of the two reactive compounds. Accordingly, any liquid containing the reactive compound (A) does not contain the reactive compound (B), and there is at least one liquid containing the reactive compound (B) but not containing the reactive compound (A). There may be liquids containing neither of the two reactive compounds. The liquids constituting the ink further include liquids each containing a polymerizable compound and liquids each containing a polymerization initiator. There is no limitation on which liquids contain the polymerizable compound nor on which liquids contain the polymerization initiator. Accordingly, there may be liquids each containing both the polymerizable compound and the polymerization initiator, there may be liquids each containing the polymerizable compound but not containing the polymerization initiator, there may be liquids each containing the polymerization initiator but not containing the polymerizable compound, and there may be liquids each containing neither the polymerizable composition nor the polymerization initiator. Further, at least one of the liquids constituting the ink contains a colorant.

As described above, in the inkjet ink of the invention, the reactive compound (A) and the reactive compound (B) capable of reacting with each other are contained in separate groups of liquids, and the reactive compounds capable of reacting with each other to cure are also included in the liquids. The liquids are provided on a recording medium at once or sequentially, whereby the above reactive compounds are allowed to react to form an image.

The reactive compound (A) and reactive compound (B) react with each other to form an aggregate or to increase the viscosity of the mixture liquid containing the reactive compounds. The reactive compound (A) and reactive compound (B) are each preferably in the liquid state at room temperature, or soluble, at room temperature, in the polymerizable compound or the polymerization initiator if the polymerizable compound or polymerization initiator coexists in the same liquid. The combination of the reactive compound (A) and reactive compound (B) may be, as a typical example, a combination of a compound containing an acidic moiety and a compound containing a basic moiety.

The colorant included in the ink of the invention may be a dye or a pigment.

In an embodiment, each of the liquids constituting the inkjet ink of the invention is a water-insoluble liquid which is free of aqueous solvents. This embodiment is preferable from the viewpoint of ink jetting stability.

A second aspect of the invention is to provide an image-forming method comprising: providing the inkjet ink of the invention on a recording medium to form an image; and applying energy to the formed image so as to cure the image.

The application of energy for curing of the image may be conducted by at least one of irradiation with an active light and heating.

The mechanism of the invention is supposed to be as described below. The reactive compound (A) and the reactive compound (B) contained in different liquids mix with each other on the recording medium to form an aggregate immediately or to increase the viscosity of the mixture liquid containing the reactive compounds immediately. Therefore, image can be formed by using ink droplets without causing intermingling of the ink droplets. Thereafter, polymerization of the polymerizable compound is initiated by application of energy to the polymerization initiator, and the polymerization cures the ink droplets to form a stable image with excellent adhesion to the recording medium.

As described above, intermingling of neighboring ink droplets is suppressed efficiently by instant formation of an aggregate or instant increase in viscosity owing to functions of the reactive compound (A) and reactive compound (B) (for example, an acidic compound and a basic compound) capable of reacting quickly. Further, polymerization of the polymerizable compound is initiated thereafter, and proceeds to form a stable image. In other words, the effects of the invention can be obtained owing to a combination of the two reaction systems each involving compounds which can interact with each other.

Further, the ink stability over time is secured by separation of the respective reactive compounds from each other. The liquids each containing the reactive compound (A) are different from the liquids each containing the reactive compound (B), whereby the reaction of the reactive compounds do not occur until they are mixed on a recording medium. The combination of the reactive compound (A) and the reactive compound (B) may be the combination of an acidic compound and a basic compound as described above. Moreover, the ink stability can be further improved if the liquids each containing the polymerizable compound are different from the liquids each containing the polymerization initiator.

### DESCRIPTION OF THE PRESENT INVENTION

In the following, the present invention is described in detail.

Inkjet Ink

The inkjet ink of the invention is described. The ink of the invention comprises a plurality of liquids including a first liquid and a second liquid. The first liquid contains a reactive compound (A) and the second liquid contains a reactive compound (B). The reactive compound (A) and the reactive compound (B) are such reactive compounds that mixing of the reactive compounds causes a reaction to form an aggregate or to increase the viscosity of the mixture liquid containing the reactive compounds. The ink of the invention does not comprise any liquid containing both of the reactive compound (A) and reactive compound (B). At least one of the liquids constituting the ink contains a polymerizable compound, and at least one of the liquids constituting the ink contains a polymerization initiator. Each of the liquids constituting the ink may or may not contain the polymerizable compound and/or the polymerization initiator, as long as the above conditions are satisfied. Further, at least one of the liquids constituting the ink contains a colorant.

In other words, the ink contains two combinations of reactive substances. One of the combinations is the combination of the reactive compound (A) and the reactive compound (B). The reactive compound (A) and reactive compound (B) react with each other when mixed, so that an aggregate is formed or the viscosity of the mixture liquid increases in a short time. In the invention, the expression “increase the viscosity of the mixture liquid” refers to the situation that the viscosity of the mixture liquid obtained by mixing a liquid containing the reactive compound (A) and a liquid containing the reactive compound (B) is increased. The reactive compound (A) is contained in separate liquids from liquids each containing the reactive compound (B). The other combination is the combination of the polymerizable compound (hereinafter occasionally referred to as “polymerizable compound (C)”) and the polymerization initiator (hereinafter occasionally referred to as “polymerization initiator (D)”). Regarding this combination, there is no limitation on the selection of liquids containing the polymerizable compound and/or the polymerization initiator, except for the requirement that at least one liquid contain the polymerizable compound and at least one liquid contain the polymerization initiator. Further, at least one liquid contains a colorant, and the liquid(s) containing the colorant may be arbitrarily selected.

In the specification, an exemplary embodiment is described in which the ink is comprised of two liquids. However, the number of the liquids constituting the ink may be three or larger. When the ink is comprised of three or more liquids, the reactive compound (A) is contained in a liquid or liquids different from the liquid or liquids containing the reactive compound (B). There may be or may not be overlap between the liquid(s) each containing the polymerizable compound and the liquid(s) each containing the polymerization initiator. In a preferable embodiment, any liquid containing the polymerizable compound does not contain the polymerization initiator from the viewpoint of stability.

In every case, at least one of the liquids constituting the ink contains a colorant as a coloring component of the ink.

In the invention, the following two reactions play important roles in the formation of good image by mixing of at least two liquids, the image having no bleed nor intermingling of ink droplets.
(a) The mixing of the first and second liquids causes rapid formation of an aggregate containing the colorant, or causes rapid increase in viscosity of the liquid containing the colorant, thereby preventing the intermingling of the neighboring ink droplets.
(b) The polymerization initiator causes polymerization of the polymerizable compound contained in the aggregate or in the liquid whose viscosity was increased, so that the polymerizable compound is cured to form an image excellent in stability and adhesion to the recording medium.

When the liquids contain an organic solvent as the solvent, the organic solvent may affect the curing property. When the liquids contain an aqueous solvent, the aqueous solvent may take time to evaporate and to disappear. Accordingly, it is preferable not to use a solvent in the liquids. From this viewpoint, the reactive compound (A) and reactive compound (B) (typically, an acidic compound and a basic compound) are preferably in the liquid state at room temperature, or soluble in the coexisting polymerizable compound and/or polymerization initiator at room temperature. In other words, it is preferable to satisfy at least one of the following conditions:

(i) the reactive compound (A) is a liquid at room temperature;

(ii) the polymerizable compound coexists in the liquid containing the reactive compound (A), and the reactive compound (A) is soluble in the polymerizable compound at room temperature; and

(iii) the polymerization initiator coexists in the liquid containing the reactive compound (A), and the reactive compound (A) is soluble in the polymerization initiator at room temperature;

and it is preferable to satisfy at least one of the following conditions:

(i) the reactive compound (B) is a liquid at room temperature;

(ii) the polymerizable compound coexists in the liquid containing the reactive compound (B), and the reactive compound (B) is soluble in the polymerizable compound at room temperature; and

(iii) the polymerization initiator coexists in the liquid containing the reactive compound (B), and the reactive compound (B) is soluble in the polymerization initiator at room temperature.

Further, active rays or heat may be applied to the liquids in order to facilitate the polymerization and curing.

In the invention, the reaction of the reactive compound (A) and the reactive compound (B) may be, for example, an acid-base reaction, a hydrogen-bonding reaction between a carboxylic acid and a compound containing an amide group, a crosslinking reaction such as a reaction of boric acid and a diol, or an electrostatic interaction of a cation with an anion. In the specification, the acid-base reaction is described as an example. When an acid-base reaction is used, for example, the reactive compound (A) may be a compound (hereinafter referred to as compound (A′)) containing an acidic moiety, and the reactive compound (B) may be a compound (hereinafter referred to as compound (B′)) containing a basic moiety.

Compound (A)

The compound (A′) may be a low-molecular-weight compound or a high-molecular-weight compound as long as the compound has an acidic group. The compound (A′) may be suitably selected in accordance with the necessity. For the reasons described above, the compound (A′) is preferably a compound which is in the liquid state at room temperature, or a compound which is soluble in the coexisting polymerizable compound and/or the polymerization initiator at room temperature. The polymerizable compound and the polymerization initiator will be described later.

The acidic group of the compound (A′) is preferably an acidic group selected from the groups (1) to (6) below.
(1) phenol groups (—Ar—OH)
(2) sulfonamide groups (—SO₂NH—R)
(3) substituted sulfonamide groups (hereinafter referred to as “active imide groups”) (such as —SO₂NHCOR, —SO₂NHSO₂R, —CONHSO₂R)
(4) carboxylic groups (—CO₂H)
(5) sulfonic acid groups (—SO₃H)
(6) phosphoric acid groups (—OPO₃H₂)

In the above examples of the acidic group, Ar represents a divalent aryl connecting group which may have a substituent, and R represents a hydrogen atom or a hydrocarbon group which may have a substituent.

Among compounds having acidic groups selected from the above (1) to (6), compounds each having (4) a carboxylic acid group or (2) a sulfonic acid group are preferable from the viewpoints of the reactivity with a basic group and effects of the invention. Compounds each having (4) a carboxylic acid group are more preferable.

The compound (A′) is preferably a polymer having an acidic group on its main chain or on any of its side chains, from the viewpoint of ink fixability.

In a preferable embodiment, the compound (A′) is a polymer having an acidic group and a polymerizable unsaturated bond represented by the following formula (I).

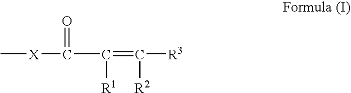

In formula (I), R¹ represents a hydrogen atom or an alkyl group which may have a substituent. R² and R³ each independently represent a hydrogen atom or a monovalent substituent. X represents an oxygen atom, a sulfur atom, or —NR⁴—, wherein R⁴ represents a hydrogen atom or a monovalent substituent.

Examples of the polymer (referred to as “acidic compound”) are shown below.

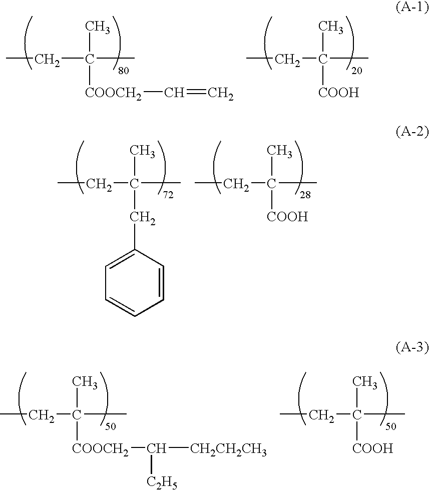

| Acidic | |
|---|---|
| Compound | Composition (mol %) |
| 1 | 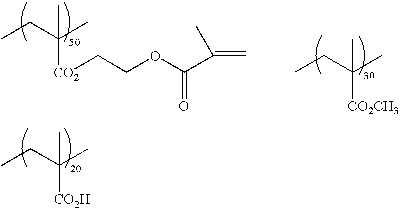 |
| 2 | 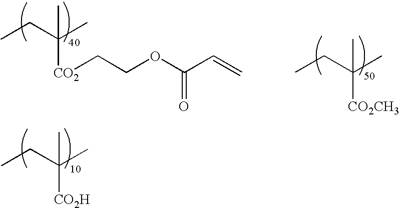 |
| 3 | 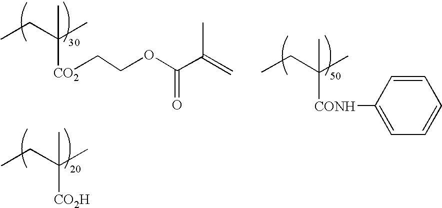 |
| 4 | 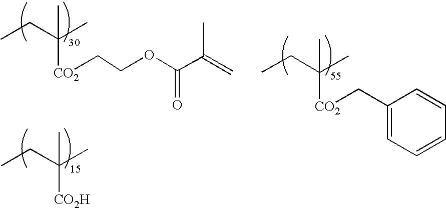 |
| 5 | 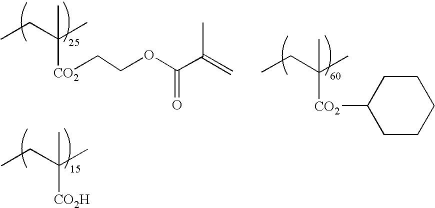 |
| 6 | 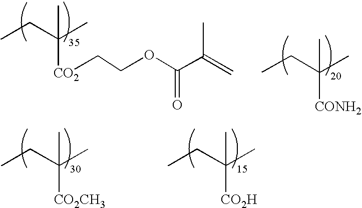 |
| 7 | 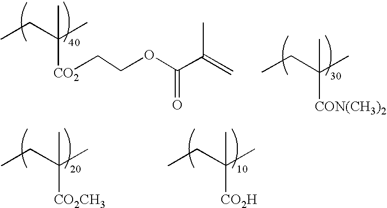 |
| 8 | 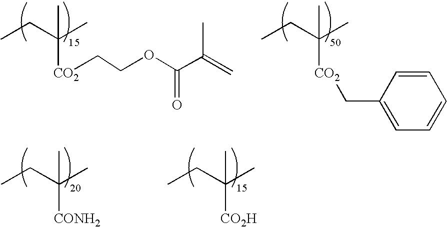 |
| 9 | 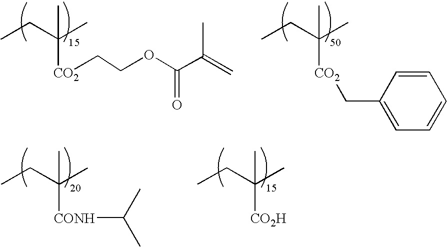 |
| 10 | 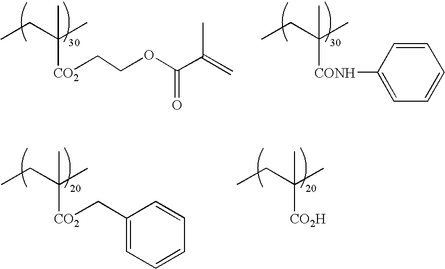 |

The polymer having an acidic group and a polymerizable group is described in detail in JP-A No. 2004-077763, the disclosure of which is incorporated by reference herein. This application was filed by the applicant of the present application. Compounds described in the reference can be used as the compound (A′) in the invention.

A compound having a carboxylic acid group and a polymerizable group such as described above also has the function as the polymerizable compound (C) described later. Since the degree of dissociation of the carboxylic acid group of the compound is low, the aggregation upon contact with the basic compound is effectively facilitated. Further, since the compound itself is a stable polymer, intermingling of the ejected droplets for different dots is suppressed by use of the compound. When such a compound is used, the compound is contained preferably in a liquid other than the liquid(s) containing the polymerization initiator (D) described later, from the viewpoint of stability.

The content (in terms of the solid content) of the compound (A′) contained in the first liquid is preferably 0.5 to 40% by mass, more preferably 1 to 20% by mass, from the viewpoint of reactivity and viscosity.

Compound (B′)

In the following, the compound (B′) containing a basic moiety is described. The compound (B′) is contained in other liquid(s) than the liquid(s) containing the compound (A′). The compound (B′) reacts with the compound (A′) on the recording medium to form an aggregate.

The compound (B′) is not particularly limited. The compound (B′) may be suitably selected from compounds capable of reacting with the compound (A′) to form an aggregate quickly.

The compound (B′) may be selected from amine compounds described later, ammonium salts (for example, compound (1) shown below), hydrazine compounds (for example, compound (2) shown below), amidine compounds (for example, compound (3) shown below), guanidine compounds (for example, compounds (4) and (5) shown below), and compounds containing nitrogen-containing heterocyclic rings such as pyrrole, imidazole, pyrazole, pyridine, pyrazine, pyrimidine, indole, purine, quinoline, and carbazole.

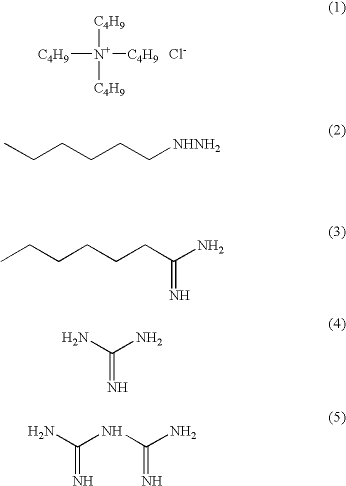

Amine compounds are preferable as the compound (B′) because amine compounds easily form aggregates upon contact with the compound (A′) and because amine compounds has good physical characteristics with respect to liquidity at room temperature, solubility in the coexisting polymerizable compound or polymerization initiator at room temperature, and the like. Primary amines and secondary amines are more preferable.

In the following, examples of amine compounds usable in the invention as the basic compound (B′) are shown below (exemplary compounds (B-1) to (B-10). However, the examples should not be construed as limiting the invention.

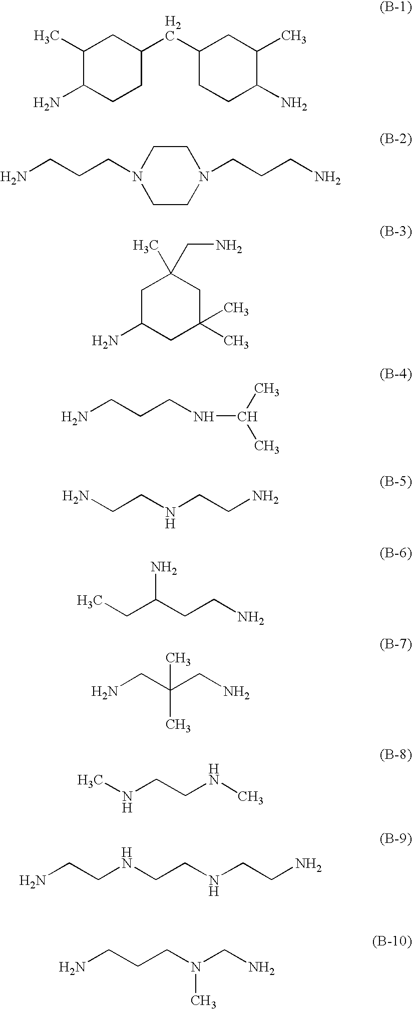

The liquids each containing the compound (B′) are different from the liquids each containing the compound (A′) in the ink of the invention. In each of the liquids containing the compound (B′), the content of the compound (B′) is preferably 50 to 99% by mass in terms of the solid content, more preferably 60 to 98% by mass in terms of the solid content, from the viewpoint of the viscosity and the reactivity.

Polymerizable Compound (C)

In the invention, at least one of the liquids constituting the ink contains a polymerizable compound (C). The polymerizable compound (C) is such a compound that polymerization of the polymerizable compound (C) is initiated by initiating species such as a radical generated by the polymerization initiator (D) described later, whereby the polymerizable compound (C) is cured.

The polymerizable compound (C) is preferably an addition-polymerizable compound having at least one ethylenic unsaturated double bond, and may be selected from compounds each having at least one terminal ethylenic unsaturated bond, preferably selected from multifunctional compounds having at least two terminal ethylenic unsaturated bonds. Such compounds are well known in the related industrial field and the polymerizable compound (C) may be selected from such compounds without particular restriction. The polymerizable compound (C) may be in the chemical form of a monomer, a prepolymer such as a dimer, a trimer, or an oligomer, a mixture thereof, or a copolymer thereof.

The polymerizable compound (C) preferably has a polymerizable group such as an acryloyl group, a methacryloyl group, an allyl group, a vinyl group, or an internal double bond group such as maleic acid. The polymerizable group is more preferably an acryloyl group or a methacryloyl group since a compound having an acryloyl group or a methacryloyl group can be cured with low energy.

The polyfunctional polymerizable compound usable in the invention may be selected from: vinyl-group-containing aromatic compounds; (meth)acrylic esters formed by combinations of (meth)acylic acid and alcohols each having at least two hydroxyl groups; (meth)acrylamides formed by combinations of (meth)acrylic acid and amides having di- or higher- valency; esters formed by combinations of polybasic acids and dihydric alcohols; polyester(meth)acrylates formed by introduction of (meth)acylic acid to polycaprolactones; polyether(meth)acrylates formed by introduction of (meth)acrylic acid to ethers obtained by combining alkyleneoxides with polyhydric alcohols; epoxy(meth)acrylates obtained by introduction of (meth)acrylic acid to epoxy resins or by reaction of di- or higher-hydric alcohols with epoxy-containing monomers; urethane acrylates having urethane bonds; amino resin acrylates; acrylic resin acrylates; alkyd resin acrylates; spiran resin acrylates; silicone resin acrylates; products of reaction of unsaturated polyesters with the above-described photopolymerizable monomers; and products of reaction of waxes with the above-described polymerizable monomers. In a preferable embodiment, the polyfunctional polymerizable compound is selected from: (meth)acrylates; polyester (meth)acrylates; polyether (meth)acrylates; epoxy acrylates; urethane acrylates; acrylic resin acrylates; silicone resin acrylates; and products of reaction of unsaturated polyesters with the above-described photopolymerizable monomers. In a more preferable embodiment, the polyfunctional polymerizable compound is selected from: acrylates; polyester acrylates; polyether acrylates; epoxy acrylates; and urethane acrylates.

In this specification, the term “(meth)acrylic acid” refers to acrylic acid or methacrylic acid or both.

Specific examples of the polyfunctional polymerizable compound include: divinylbenzene; 1,3-butanediol diacrylate; 1,6-hexanediol diacrylate; pentaerythritol triacrylate; trimethylolpropane triacrylate; dipentaerythritol hexaacrylate; 1,6-acryloylaminohexane; hydroxypivalic acid ester neopentylglycol diacrylate; polyester acrylates in which (meth)acryloyl groups are attached to terminals of molecular chains of polyesters each formed by a dibasic acid and a dihydric alcohol, the polyesters each having a molecular weight in the range of 500 to 30000; polyethyleneglycol diacrylates;; epoxy acrylates having skeletons each selected from bisphenol A, bisphenol S, and bisphenol F and having molecular weights in the range of 450 to 30000; epoxy acrylates having phenol-novolac resin skeletons and having molecular weights in the range of 600 to 30000; products of reaction of (meth)acrylic acid monomers having hydroxyl groups with polyvalent isocyanates having molecular weights in the range of 350 to 30000; and modified products of urethanes having urethane bonds.

The monofunctional polymerizable monomer usable in the invention may be a (meth)acrylate, styrene, acrylamide, a vinyl-group-containig monomer (such as a vinyl ester, a vinyl ether, or an N-vinylamide), or (meth)acrylic acid, preferably a (meth)acrylate, acrylamide, a vinyl ester, or a vinyl ether, more preferably a (meth)acrylate or acrylamide. Such polymerizable monomers each may have a substituent. The substituent may be a halogen atom, a hydroxyl group, an amide group, or a carboxylic acid group.

Specific examples of the monofunctional polymerizable monomer include: hydroxyethyl acrylate; glycidyl acrylate; tetrahydrofurfuryl acrylate; dicyclopentenyl acrylate; 2-acryloyloxyethyl phosphate; allyl acrylate; N,N-dimethylaminoethyl acrylate; N,N-dimethylacrylamide; N,N-diethylaminopropylacrylamide; N-butoxymethylacrylamide; acryloyl morpholine; 2-hydroxyethylvinyl ether; N-vinylformamide; N-vinylacetamide; 2-cyclohexylcarbamoyloxyethyl acrylate; acrylates each having a polybutyl acrylate moiety in the ester portion; and acrylates each having a polydimethylsiloxane moiety in the ester portion.

When the compound (A′) is a polymer having a carboxylic acid group and a polymerizable group as described above, a separate polymerizable compound (C) is unnecessary since the polymer functions as a polymerizable compound (C). However, it is preferable to use a separate polymerizable compound (C) even in such a case, from the viewpoint of obtaining sufficient effects.

Only a single polymerizable compound (C) may be used or two or more polymerizable compounds (C) may be used in combination.

In the liquid(s) containing the polymerizable compound (C), the content of the polymerizable compound (C) is preferably 50 to 99.6% by mass in terms of the solid content, more preferably 70 to 99.0% by mass in terms of the solid content, still more preferably 80 to 99.0% by mass in terms of the solid content.

Polymerization Initiator (D)

In the invention, at least one of the liquids constituting the ink contains a polymerization initiator (D). The liquid(s) containing the polymerization initiator (D) each may or may not contain the polymerizable compound (C). In a preferable embodiment, any liquid containing the polymerization initiator (D) does not contain the polymerizable compound (C) in consideration of stability over time. When energy is applied to the polymerizable compound (C) and the polymerization initiator (D) on the recording medium, polymerization and curing occur.

The polymerization initiator (D) is a compound which generates an initiating species such as a radical upon application of light, heat, or both, thereby initiating and promoting polymerization of the polymerizable compound (C). The polymerization initiator (D) in the invention may be selected from known thermal polymerization initiators, compounds having bonds with low bond-dissociation energy, and photopolymerization initiators.

Examples of such radical generators include organic halogenated compounds, carbonyl compounds, organic peroxide compounds, azo-based polymerization initiators, azide compounds, metallocene compounds, hexaarylbiimidazole compounds, organic boric acid compounds, disulfonic acid compounds, and onium salt compounds.

Preferable examples of the polymerization initiator (D) in the invention include the following photopolymerization initiators: acetophenone derivatives, benzophenone derivatives, benzyl derivatives, benzoin derivatives, benzoin ether derivatives, benzyldialkylketal derivatives, thioxanthone derivatives, acylphosphine oxide derivatives, metal complexes, p-dialkylaminobenzoic acid, azo compounds, and peroxide compounds. As the polymerization initiator (D), preferable are acetophenone derivatives, benzyl derivatives, benzoin ether derivatives, benzyldialkylketal derivatives, thioxanthone derivatives, and acylphosphine oxide derivatives. Still more preferable are acetophenone derivatives, benzoin ether derivatives, benzyldialkylketal derivatives and acylphosphine oxide derivatives.

Specific examples of the photopolymerization initiator include acetophenone, 2,2-diethoxyacetophenone, p-dimethylaminoacetophenone, p-dimethylaminopropiophenone, benzophenone, p,p′-dichlorobenzophenone, p,p′-bisdiethylaminobenzophenone, Michler's ketones, benzyl, benzoin, benzoin methyl ether, benzoin isopropyl ether, benzoin-n-propyl ether, benzoin isobutyl ether, benzyl dimethyl ketal, 1-hydroxy-cyclohexyl phenyl ketone, tetramethylthiram monosulfide, thioxanthone, 2-chlorothioxanthone, 2,4-dimethylthioxanthone, 2,2-dimethylpropionyl diphenylphosphine oxide, 2-methyl-2-ethylhexanoyl diphenylphosphine oxide, 2,6-dimethylbenzoyl diphenylphosphine oxide, 2,6-dimethoxybenzoyl diphenylphosphine oxide, 2,4,6-trimethylbenzoyl diphenylphosphine oxide, bis(2,6-dimethoxybenzoyl)-2,4,4-trimethylpentylphosphine oxide, 2,3,6-trimethylbenzoyl-diphenylphosphine oxide, bis(2,3,6-trimethylbenzoyl)-phenylphosphine oxide, 2,4,6-trimethoxybenzoyl-diphenylphosphine oxide, 2,4,6-trichlorobenzoyl diphenylphosphine oxide, 2,4,6-trimethylbenzoyl naphtylphosphonate, bis(η5-2,4-cyclopentadiene-1-yl)-bis(2,6-difluoro-3(1H-pyrrole-1-yl)-phenyl)titanium, p-dimethylaminobenzoic acid, p-diethylaminobenzoic acid, azobisisobutyronitrile, 1,1′-azobis(1-acetoxy-1-phenylethane), benzoin peroxide, and di-tert-butyl peroxide.

Other preferable examples of the photopolymerization initiator include the photopolymerization initiators disclosed in Seishi Kato “Shigaisen Kouka System” (UV curing system) published by Sougou Gijutsu Center Co., Ltd (currently Extensive Technology Service Co.,Ltd) (1989), pp. 65-148, the disclosure of which is incorporated herein by reference.

The sensitivity of the polymerization initiator is preferably high. From the viewpoint of storage stability, it is not preferable to use a polymerization initiator which thermally decomposes, for example at 80° C. or lower. Accordingly, it is preferable to select a polymerization initiator which does not thermally decompose at 80° C. or lower.

Only a single polymerization initiator (D) may be used, or two or more polymerization initiators (D) may be used in combination. The polymerization initiator (D) may be used together with a known sensitizer for the purpose of improving the sensitivity, as long as the effects of the invention can be achieved.

In a preferable embodiment, the liquid(s) each containing the polymerization initiator (D) is/are different from the liquid(s) each containing the polymerizable compound (C). In each of the liquids containing the polymerization initiator (D), the content of the polymerization initiator (D) is preferably 0.5 to 20% by mass, more preferably 1 to 15% by mass, still more preferably 3 to 10% by mass, from the viewpoints of the stability over time, the curability, and the curing rate. Excessively high content of the polymerization initiator is not preferable since precipitation or separation may occur over time and since the strength or abrasion resistance of the cured ink may be deteriorated.

Colorant (E)

At least one of the liquids constituting the inkjet ink of the invention contains a colorant (hereinafter occasionally referred to as “colorant E”). The colorant to be used in the invention is not particularly limited, and may be selected from known water-soluble dyes, oil-soluble dyes, and pigments, as long as the selected dye or pigment can achieve a hue and color density suitable for the intended purpose of the ink. As described above, the liquids constituting the inkjet ink of the invention are preferably water-insoluble liquids which are free of aqueous solvents, from the viewpoint of ink ejecting property. From the viewpoint, the colorant is preferably an oil-soluble dye or a pigment which can be uniformly dissolved or dispersed in a water-insoluble liquid.

(Oil-Soluble Dye)

The oil-soluble dye usable in the invention is not particularly limited, and may be an arbitrarily selected oil-soluble dye. Examples of oil-soluble dyes usable in the invention are described below for respective hues.

Examples of yellow dyes include: aryl azo dyes having coupling components selected from phenols, naphthols, anilines, pyrazolones, pyridones, and open-chain active methylene compounds; heteryl azo dyes having coupling components selected from phenols, naphthols, anilines, pyrazolones, pyridones, and open-chain active methylene compounds; azo methine dyes having open-chain active methylene compounds as coupling components; methine dyes such as benzylidene dyes and monomethine oxonol dyes; quinone dyes such as naphthoquinone dyes and anthraquinone dyes; quinophthalone dyes; nitro dyes; nitroso dyes; acridine dyes; and acridinone dyes.

Examples of magenta dyes include: aryl azo dyes having coupling components selected from phenols, naphthols, and anilines; heteryl azo dyes having coupling components selected from phenols, naphthols, and anilines; azo methine dyes having coupling components selected from pyrazolones and pyrazolotriazoles; methine dyes such as arylidene dyes, styryl dyes, melocyanine dyes, and oxonol dyes; carbonium dyes such as diphenylmethane dyes, triphenylmethane dyes, and xanthene dyes; quinone dyes such as naphthoquinone, anthraquinone, and anthrapyridone; and condensed-ring polycyclic dyes such as dioxazine dyes.

Examples of cyan dyes include: indoaniline dyes; indophenol dyes; azo methine dyes having pyrrolotriazoles as coupling components; polymethine dyes such as cyanine dyes, oxonol dyes, and melocyanine dyes; carbonium dyes such as diphenylmethane dyes; triphenylmethane dyes, and xanthene dyes; phthalocyanine dyes; anthraquinone dyes; arylazo dyes having coupling components selected from phenols, naphthols, and anilines; heterylazo dyes having coupling components selected from phenols, naphthols, and anilines; indigo dyes; and thioindigo dyes.

Each of the above dyes may be a dye which develops yellow, magenta, or cyan only after dissociation of a part of the coloring atomic group (chromophore); in this case, the counter-cation may be an inorganic cation such as an alkali metal or ammonium, or an organic cation such as pyridinium or a quaternary ammonium salt, or a polymer cation having such an inorganic or organic cation as a partial structure.

When the colorant (E) is an oil-soluble dye, the content of the oil-soluble dye in each of the liquid(s) containing the oil-soluble dye is preferably 0.05 to 20% by mass in terms of the solid content, more preferably 0.1 to 15% by mass in terms of the solid content, still more preferably 0.2 to 6% by mass in terms of the solid content.

In another embodiment, a pigment is used as the colorant (E). Use of a pigment is preferable since aggregation easily occurs when the liquids constituting the ink of the invention are mixed.

The pigment may be an organic pigment or an inorganic pigment. Carbon black is preferable as a black pigment. Although a black pigment and pigments of three primary colors of cyan, magenta, and yellow are used in general, pigments of other hues may be used in accordance with the purpose. Examples of the pigments of other hues include pigments of hues such as red, green, blue, brown, and white, pigments with metallic luster such as gold color and silver color, and uncolored or light-colored body pigments.

Examples of the pigment further include: particles obtained by coating and fixing a dye or a pigment on a core material made of silica, alumina, a resin, or the like; lake pigments obtained by imparting insolubility to dyes; colored emulsions, and colored latexes.

The pigment may be coated with a resin. Such a pigment is called “microcapsule pigment”, and is commercially available from Dainippon Ink and Chemicals Incorporated and Toyo Ink MFG Co., Ltd., and the like.

The volume-average particle diameter of the pigment particles contained in the liquid is preferably 30 to 250 nm, more preferably 50 to 200 nm, from the viewpoint of the balance of the optical density and the storage stability. The volume-average particle diameter of the pigment particles can be measured by a measuring instrument such as LB-500 manufactured by Horiba Ltd.

When the colorant (E) is a pigment, the content of the pigment in each of the liquids containing the pigment is preferably 0.1% by mass to 20% by mass in terms of the solid content, more preferably 1% by mass to 10% by mass in terms of the solid content, from the viewpoint of the optical density and ejecting stability.

Only a single colorant may be used, or a mixture of two or more colorants may be used.

In the inkjet ink of the invention, at least one of the liquids constituting the ink contains the colorant (E). In an embodiment, the colorant (E) is contained in two or more of the liquids. When there are two or more liquids each containing a colorant, the respective liquids may contain different colorants or there may be two or more liquids containing the same colorant.

As described above, the following conditions are satisfied in the liquids constituting the inkjet ink of the invention:

at least one of the liquids includes the reactive compound (A) (such as the acidic compound (A′));

at least one of the liquids includes the reactive compound (B) (such as the basic compound (B′));

the liquid(s) each including the reactive compound (A) is/are different from the liquid(s) each including the reactive compound (B);

at least one of the liquids includes the polymerizable compound (C);

at least one of the liquids includes the polymerization initiator (D); and

at least one of the liquids includes the colorant (E).

There may or may not be overlap between the liquid(s) each including the polymerizable compound (C) and the liquid(s) each including the polymerization initiator (D). The liquid(s) including the colorant (E) may be arbitrarily selected.

When the ink is comprised of two liquids (the first liquid and the second liquid), examples of the combination of respective components include the following combinations:

(1) the first liquid includes the reactive compound (A), the polymerizable compound (C), and the colorant (E), while the second liquid includes the reactive compound (B) and the polymerization initiator (D);

(2) the first liquid includes the reactive compound (A), the polymerization initiator (D), and the colorant (E), while the second liquid includes the reactive compound (B) and the polymerizable compound (C);

(3) the first liquid includes the reactive compound (A) and the polymerization initiator (D), while the second liquid includes the reactive compound (B), the polymerizable compound (C), and the colorant (E);

(4) the first liquid includes the reactive compound (A) and the polymerizable compound (C), while the second liquid includes the reactive compound (B), the polymerization initiator (D), and the colorant (E); and

(5) the first liquid includes the reactive compound (A), the polymerizable compound (C), the polymerization initiator (D), and the colorant (E), while the second liquid includes the reactive compound (B) and the colorant (E).

Each of the liquids constituting the ink may further include known additives in accordance with the purpose.

Other Components

Storage Stabilizer

In the invention, a storage stabilizer may be added to the ink for the purpose of preventing undesirable polymerization during storage of the ink. It is preferable to add a storage stabilizer to the liquid(s) containing the polymerizable compound (C). The storage stabilizer is preferably soluble in the liquid(s) or other coexisting components in the liquid(s).

Examples of the storage stabilizer include quaternary ammonium salts, hydroxyamines, cyclic amides, nitrites, substituted ureas, heterocyclic compounds, organic acids, hydroquinones, hydroquinone monoethers, organic phosphines, and copper compounds. Specific examples thereof include benzyltrimethylammonium chloride, diethylhydroxylamine, benzothiazole, 4-amino-2,2,6,6-tetramethylpiperidine, citric acid, hydroquinone monomethyl ether, hydroquinone monobutyl ether, and copper naphthenate.

The amount of the storage stabilizer to be added may be suitably selected in consideration of the activity of the polymerization initiator to be used, the polymerizability of the polymerizable compound, and the type of the storage stabilizer. In each of the liquids containing the storage stabilizer, the content of the storage stabilizer is preferably 0.005 to 1% by mass in terms of the solid content, more preferably 0.01 to 0.5% by mass in terms of the solid content, still more preferably 0.01 to 0.2% by mass in terms of the solid content, from the viewpoint of the balance of the storage stability and the curability of the ink at mixing of the liquids.

Conductive Salts

Conductive salts are solid compounds which dissolve in ink to heighten the conductivity of the ink. In the invention, it is preferable to use substantially no conductive salts since the conductive salts are likely to precipitate during storage. However, an adequate amount of a conductive salt may be used if the solubility of the conductive salt in the liquid component of the ink is high. The conductive salt may be potassium thiocyanate, lithium nitrate, ammonium thiocyanate, or dimethylamine hydrochloride.

The liquids constituting the ink of the invention are preferably free of water. When the ink includes water, the ink may become inhomogeneous, the ink may become turbid owing to precipitation of the dye or the like. Accordingly, such an ink has inferior stability over time. Further, the ink including water does not dry quickly when provided on a recording medium which has low water absorbability.

The inkjet ink of the invention may include other additives such as solvents, polymers, surface tension controlling agents, UV absorbers, antioxidants, antifading agents, and pH controllers.

A solvent may be used in the ink for the purpose of improving the ink polarity, the ink viscosity, the surface tension of the ink, and the solubility or dispersability of the colorant, and for the purpose of adjusting the electric conductivity of the ink and the printing performance. The solvent may be water, a low-boiling organic solvent, or a high-boiling organic solvent. For the reasons described above, the solvent is preferably non-aqueous.

The low-boiling organic solvent is an organic solvent having a boiling point of 100° C. or lower. Use of the low-boiling organic solvent is not preferable in consideration of environmental contamination. When the low-boiling organic solvent is used, the low-boiling organic solvent is preferably a sufficiently safe low-boiling organic solvent. The sufficiently safe low-boiling organic solvent refers to a low-boiling organic solvent whose standard control concentration (the index shown in a work environment evaluation standards) is 100 ppm or higher, more preferably 200 ppm or higher. Examples of the sufficiently safe low-boiling organic solvent include alcohols, ketones, esters, ethers, and hydrocarbons. Specific examples thereof include methanol, 2-butanol, acetone, methyl ethyl ketone, ethyl acetate, and tetrahydrofuran.

The high-boiling organic solvent is an organic solvent having a boiling point above 100° C. The high-boiling organic solvent is preferably an organic solvent having a boiling point of 150° C. or higher, more preferably 170° C. or higher. Examples thereof include polyhydric alcohols, esters of aliphatic carboxylic acid, phosphoric esters, and hydrocarbons. Specific examples thereof include diethyleneglycol, trimethylolpropane, dibutyl phthalate, 2-ethylhexyl benzoate, and an alkyl naphthalene. The high-boiling organic solvent may be a liquid or a solid at room temperature, depending on the purpose.

Only a single solvent may be used, or two or more solvents may be used in combination. The amount of the solvent to be used is preferably 0 to 20% by mass, more preferably 0 to 10% by mass. In a preferable embodiment, the ink includes substantially no solvent; in other words, the ink includes no solvent except for the solvents as impurities which are inevitably contained in the ink.

The surface tension controlling agent, UV absorber, antioxidant, antifading agent, and pH adjuster may be each selected from known compounds. For example, the additives disclosed in JP-A 2001-181549 (the disclosure of which is incorporated herein by reference) can be used in the invention.

Preferable physical properties of the liquids constituting the inkjet ink vary depending on the printer to be used. In general, the viscosity of each liquid is preferably 5 to 100 mPa.s, more preferably 10 to 80 mPa.s. The surface tension of the ink composition is preferably 20 to 60 mN/m, more preferably 30 to 50 mN/m.

When the liquids are ejected onto the recording medium, the liquids are mixed. For example, when the ink is comprised of two liquids, the ejected first and second liquids are mixed with each other on the recording medium. Then, the reactive compound (A) and the reactive compound (B) react with each other to form an aggregate. The colorant (E) is also included in the aggregate. When the aggregate including the colorant (E) is formed, intermingling of the neighboring droplets is prevented, occurrence of bleeding of the colorant (E) is suppressed, whereby dots can be obtained which are excellent in the optical density and free from bleeding or intermingling of droplets.

In the interior of the aggregate, active species such as radicals generated by the polymerization initiator (D) initiates polymerization of the coexisting polymerizable compound (C) and the polymerization proceeds so that the aggregate is cured. As the result, a stable image is formed which is firmly fixed to the recording medium.

Image-Forming Method

The image-forming method of the invention is described in the following. The image-forming method of the invention uses the inkjet ink of the invention described above.

The image-forming method of the invention comprises ejecting the inkjet ink of the invention onto a recording medium to form an image, and applying energy to the image to cure the image.

As described above, the liquids constituting the inkjet ink are mixed on the recording medium to form an aggregate including the colorant, and the polymerizable compound polymerizes in the aggregate to form a cured image. By applying energy, the polymerization and curing in the aggregate are enhanced, thereby enabling efficient formation of a stronger image. The application of energy is conducted preferably by heating or irradiation with a light.

The image-forming method of the invention employs a known recording method for image formation with the inkjet ink of the invention. When the recording method is an inkjet recording method, the ink nozzles to be used is not particularly limited, and may be selected in accordance with the purpose.

The ink of the invention can be applied to a known recording medium to form an image. The recording medium may be plain paper, a resin coated paper, an inkjet-specific paper, a film, a multi-use paper compatible with inkjet and electrophotography, cloth, glass, a metal, or ceramics. In the invention, the recording medium may be selected from the media described as “image-receiving member” in JP-A No. 2001-181549 (the disclosure of which is incorporated herein by reference).

The inkjet ink of the invention can be applied to any inkjet recording system. The recording system may be, for example: the charge controlling system in which electrostatic attractive force is utilized for ejecting the ink; the drop-on-demand system (pressure pulse system) in which vibration pressure of a piezo element is utilized; the acoustic inkjet system in which acoustic beams are generated by conversion of electric signals and applied to the ink so that the ink is ejected by radiation pressure; or the thermal inkjet system (the BUBBLE JET system (registered trade name)) in which the ink is heated to generate bubbles such that the generated pressure is utilized for ejecting.

The inkjet recording system may be a system in which many small droplets of an ink having a low color density (which is called “photoink”) are ejected, a system in which the image quality is improved by using a plurality of inks of the same hue having respectively different color density, or a system in which a transparent ink is used.

By using an inkjet recording method such as described above, the liquids of the ink (for one dot) are applied to a recording medium at once or sequentially to form an image. When the ink is applied to the recording medium, the ink is applied such that the liquids of the ink contact with each other. It is not particularly limited how the liquids contact with each other. In one embodiment, the liquids are ejected next to each other. In another embodiment, the liquids are ejected to the same area.

The timing of ejecting may be arbitrary. In an embodiment, the liquids of the ink are ejected simultaneously. In another embodiment, the liquids are ejected sequentially. When the liquids are ejected sequentially, all of the liquids are ejected preferably within 1 second. The mass of the droplets is not particularly limited, and may be selected in accordance with the sharpness of the image to be formed. Generally, the mass of each droplet of each liquid is preferably 0.5 pl to 10 pl.

In the invention, the balance of the amounts of respective liquids to be applied for one dot is, in the case of the ink comprised of two liquids, preferably such that the ratio of the applied amount of the first liquid to the applied amount of the second liquid is in the range of 0.5:5 to 5:0.5 from the viewpoints of the reactivity and the viscosity.

In the following, the method for applying energy in the subsequent process is described. When energy application is conducted such as exposure to light or heating, generation of active species by decomposition of the polymerization initiator (D) in the mixed droplet is enhanced, and the polymerization and curing of the polymerizable compound (C) caused by the active species are enhanced by increase in the active species or temperature.

In the invention, the exposure light source for promoting polymerization of the monomer may be a UV light source or a visible-light source. Although radiations other than light such as α-ray, γ-ray, X-ray, and electron beams may be used for applying energy, UV light and visible light are preferable from the viewpoints of the cost and the safety. Use of UV light is more preferable. The energy required for the curing reaction vary depending on the type and content of the polymerization initiator, and is generally 1 to 500 mJ/cm².

When the energy is applied by heating, it is preferable to conduct heating for 0.1 to 1 second such that the surface temperature of the recording medium becomes 40 to 80° C.

The heating may be conducted in a non-contact manner. In an embodiment, the recording medium is heated by being transferred through a heating unit such as an oven. In another embodiment, the entire surface of the recording medium is exposed to a light in the wavelength range of from ultraviolet to infrared. The light source used for the exposure as the heating means may be a metal halide lamp, a xenon lamp, a tungsten lamp, a carbon arc lamp, or a mercury lamp.

The ink of the invention comprising a plurality of liquids has the following advantages:

each liquid is highly stable;

an image with sufficient optical density free of bleeding or intercolor bleeding can be formed with a short drying time since an aggregate including the colorant is quickly formed after the liquids are applied to a recording medium;

the liquids are stable in the recording instrument; and

the liquids provide satisfactory long-term ejecting property.

With such advantages, the inkjet ink of the invention can be applied to a wide variety of uses.

### EXAMPLES

In the following, the invention is described in more details with reference to Examples. However, Examples should not be construed as limiting the invention.

(Preparation of Liquid (I-1) containing Acidic Compound for Inset Ink)

The following components are mixed by stirring to give a liquid (I-1) for a magenta ink.

Above-illustrated acidic compound (A-1) as the reactive compound (A) (acidic compound (A′) in this case) 3.56 g

Monomer “DPCA60” manufactured by Nippon Kayaku Co., Ltd. as the polymerizable compound (C) 1.07 g

Monomer: 1,6-hexanediol diacrylate (HDDA manufactured by Daicel UBC Co., Ltd.) as the polymerizable compound (C) 8.53 g

N-ethyldiethanolamine 0.29 g

Compound (M-1) shown below as the colorant (E) 0.46 g

The viscosity of the liquid (I-1) was 19.6 mPa.s (at 25° C.; in the following, the disclosed viscosity values are viscosity values at 25° C.). 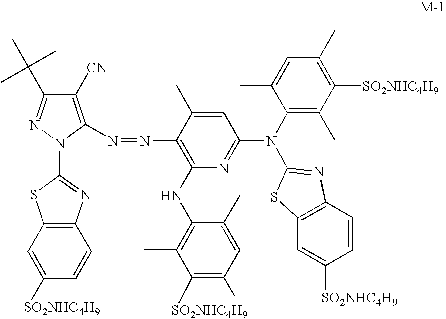
(Preparation of Liquid (II-1) Containing Basic Compound for Inkjet Ink)

The following components were mixed to form a liquid (II-1) for an inkjet ink.

Above-illustrated exemplary compound (B-1) as the reactive compound (B) (in this case, the basic compound (B′)) 5.0 g

TPO-L which is shown below as “initiator 1” as the polymerization initiator (D) 0.75 g

The viscosity of the liquid (II-1) was 10.3 mPa.s. 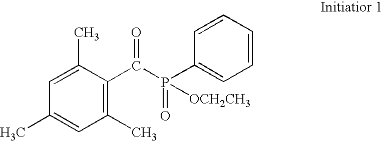
(Preparation of Liquids (I-2) And (I-3) each Containing Acidic Compound for Inkjet Ink)

Liquids (1-2) and (1-3) for an inkjet ink were prepared in the same manner as the preparation of the liquid (I-1) except that the acidic compounds shown in Table 1 below were used in place of the acidic compound (A-1).

The acidic compounds used in the respective liquids and the viscosities of the respective liquids are shown in Table 1.

TABLE 1

| | | Liquid Viscosity |
|---|---|---|
| Liquid for Ink | Acidic Compound | (mPa · s) |
| I-1 | A-1 | 17 |
| I-2 | A-2 | 12 |
| I-3 | A-3 | 10 |

(Preparation of Liquids (II-2) to (II-10) each Containing Basic Compound for Inkjet Ink)

Liquids (II-2) to (II-10) were prepared in the same manner as the preparation of the liquid (II-1) except that the basic compounds shown in Table 2 below were used in place of the basic compound (B-1). The basic compounds used in the preparation of the respective liquids, and the viscosities of the respective liquids are shown in Table 2.

TABLE 2

| | Basic Compound | Liquid Viscosity |
|---|---|---|
| Liquid for Ink | (Exemplary Compound) | (mPa · s) |
| II-1 | B-1 | 201 |
| II-2 | B-2 | 122 |
| II-3 | B-3 | 1.31 |
| II-4 | B-4 | 54.8 |
| II-5 | B-5 | 10.3 |
| II-6 | B-6 | 3.86 |
| II-7 | B-7 | 9.7 |
| II-8 | B-8 | 22.3 |
| II-9 | B-9 | 46.4 |
| II-10 | B-10 | 7.76 |

(Preparation of Liquid (I—C) Not Containing Acidic Compound for Comparative Inkjet Ink)

A liquid (I—C) was prepared in the same manner as the preparation of the liquid (I-1) except that the acidic compound A-1 was not added. The viscosity of the liquid (I—C) was 13.6 mPa.s.

(Preparation of Comparative Inkjet Ink Composition D containing Neither Acidic Compound Nor Basic Compound)

The following components were mixed by stirring to form a comparative magenta ink composition D.

Monomer “DPCA60” manufactured by Nippon Kayaku Co., Ltd. as the polymerizable compound (C) 1.0 g

Monomer: 1,6-hexanediol diacrylate (HDDA manufactured by Daicel UBC Co., Ltd.) as the polymerizable compound (C) 16.0 g

N-ethyldiethanolamine 0.6 g

Compound (M-1) as the colorant (E) 0.46 g

TPO-L as the polymerization initiator (D) 0.5 g

The viscosity of the ink composition D was 20.2 mPa.s.

Evaluation

The prepared liquids (I-1) to (1-3), (I—C), (II-1) to (II-10), and the comparative ink composition D were used for printing with an inkjet printer (an experimental model manufactured by Microjet Ltd.: printing density was 300 dpi, ejecting frequency was 4 KHz, and the number of nozzles was 64 aligned in two rows). Except for the case of the ink composition D, two liquids were used for printing in each case, and the first liquid was selected from the liquids (I-1) to (1-3) and (I—C) while the second liquid was selected from the liquids (II-1) to (II-10), as shown in Table 3. The first liquid and the second liquid were applied to a recording medium such that the two liquids overlap each other. In the case of the ink composition D, the ink composition D alone was applied to a recording medium.

The recording medium was a 60 μm-thickness polyethylene terephthalate (PET) sheet, or an art paper.

After the printing, the printed medium was irradiated with a UV light at a UV intensity of about 200 mJ/cm², using a 365 nm metal halide lamp, to form the image.

The types of the first liquid and the second liquid are shown in Table 3 for each printing. The obtained image was evaluated with respect to the following properties. The results are shown in Table 3.

(Evaluation of Intermingling of Applied Droplets)

(Line Image Quality)

The first liquid and the second liquid were applied to the recording medium to form a line image such that the two liquids overlapped each other. The overlap between the formed dots was evaluated according to the following criterion.
A: there was no significant overlap between the printed dots (in other words, there was hardly any intermingling of droplets) and there was no irregularity in the printed image;
B: slight overlap was observed between the printed dots, and the line quality was slightly inferior;
C: remarkable overlap was observed between the printed dots, and the line quality was inferior.
   (Solid Image Quality)

The first and second liquids were applied to the recording medium to form a solid image. The unevenness of the optical density was evaluated according to the following criterion.
A: unevenness of optical density in the solid image was hardly observable;
B: slight unevenness of optical density in the solid image was observable;
C: unevenness of optical density in the solid image was clearly observable and the image quality was inferior.
   (Evaluation of Adhesiveness)

The adhesiveness of the printed surface was evaluated by touching the printed surface, according to the following criterion.
A: the printed surface was not adhesive;
B: the printed surface was slightly adhesive;
C: the printed surface was quite adhesive.
   (Evaluation of Abrasion Resistance)

30 minutes after the image formation, the printed surface of the PET sheet or art paper was rubbed with a gum eraser for ten strokes, and the change of the image was observed. The observed change was classified into three levels according to the following criterion.
A: the optical density of the image was not decreased at all;
B: the optical density of the image was slightly decreased;
C: the optical density of the image was significantly decreased.
   (Evaluation of Light Resistance)

The recording medium having the image was irradiated with a xenon light (85000 1×) for four days, using a weather meter (ATLAS C.I 65). The image density before the irradiation and the image density after the irradiation were measured by a reflection density meter (X-RITE 310 TR) and the light resistance was evaluated in terms of the colorant residual ratio. The reflection density of the image before the irradiation was about 1.0. The evaluation criterion was as follows:
A: the colorant residual ratio was 90% or higher;
B: the colorant residual ratio was 80% or higher but lower than 90%;
C: the colorant residual ratio was 70% or higher but lower than 80%;
D: the colorant residual ratio was 50% or higher but lower than 70%;
E: the colorant residual ratio was lower than 50%.
   (Evaluation of Ozone Resistance)

The recording medium was stored under an ozone concentration of 5.0 ppm for three days. The reflection density before the storage and the reflection density after the storage were measured by X-RITE 310 and the measured values were used for calculate the colorant residual ratio. The evaluation criterion was as follows:
A: the colorant residual ratio was 90% or higher;
B: the colorant residual ratio was 80% or higher but lower than 90%;
C: the colorant residual ratio was 70% or higher but lower than 80%;
D: the colorant residual ratio was 50% or higher but lower than 70%;
E: the colorant residual ratio was lower than 50%.

The results of the evaluations are shown in Table 3.

TABLE 3

| Liquid for Ink | | Line | Solid | | | | | |
|---|---|---|---|---|---|---|---|---|
| (First Liquid- | Recording | Image | Image | Adhe- | Abrasion | Light | Ozone | |
| Second Liquid) | medium | Quality | Quality | siveness | Resistance | Resistance | Resistance | Remarks |
| I-1/II-1 | PET | A | A | A | A | A | A | Invention |
| I-1/II-1 | Art Paper | A | A | A | A | A | A | Invention |
| I-1/II-2 | PET | B | B | B | B | A | A | Invention |
| I-1/II-3 | PET | A | A | A | A | A | A | Invention |
| I-1/II-4 | PET | A | A | A | A | A | A | Invention |
| I-1/II-5 | PET | A | A | A | A | A | A | Invention |
| I-1/II-5 | Art Paper | A | A | A | A | A | A | Invention |
| I-1/II-6 | PET | A | A | A | A | A | A | Invention |
| I-1/II-7 | PET | A | A | A | A | A | A | Invention |
| I-1/II-8 | PET | A | A | A | A | A | A | Invention |
| I-1/II-9 | PET | A | B | B | B | A | A | Invention |
| I-1/II-10 | PET | A | A | A | A | A | A | Invention |
| I-2/II-5 | PET | A | A | A | A | A | A | Invention |
| I-2/II-5 | Art Paper | A | A | A | A | A | A | Invention |
| I-3/II-5 | PET | A | A | A | A | A | A | Invention |
| I-3/II-5 | Art Paper | A | A | A | A | A | A | Invention |
| I-C/II-5 | PET | C | C | A | A | A | A | Comp. Ex. |
| I-C/II-5 | Art Paper | C | C | A | A | A | A | Comp. Ex. |
| Ink Composition D | PET | C | C | A | A | A | A | Comp. Ex. |
| Ink Composition D | Art Paper | B | B | A | A | A | A | Comp. Ex. |

In Examples of the invention, the first liquid was selected from the liquids (I-1) to (I-3) and the second liquid was selected from (II-1) to (II-10), and it was confirmed that an aggregate was formed when the first and second liquids were mixed. As is clear from the results shown in Table 3, when the first liquid was selected from the liquids (I-1) to (I-3) and the second liquid was selected from (II-1) to (II-10) and the printing was conducted such that the first and second liquids overlap each other, image formation occurred quickly on the non-ink-absorbing PET sheet or art paper without intermingling of the ink droplets for different dots. Further, curing reaction proceeded quickly by irradiation with a ultraviolet light at about 200 mJ/cm² emitted from a 365 nm metal halide lamp, whereby a non-adhesive image excellent in the printing performance, the abrasion resistance, the light resistance and the ozone resistance was obtained.

When the liquid (I—C) not containing an acidic component was used as the first liquid, the obtained image was a non-adhesive image with excellent abrasion resistance, light resistance, and ozone resistance and with stable image quality. However, image forming property was unsatisfactory owing to intermingling of the ink droplets on the PET sheet or on the art paper. Therefore, the liquid (I—C) is not suitable for forming a high-quality image.

Further, when the ink composition D including the polymerizable compound (C) and the polymerization initiator (D) was used for printing, non-adhesive image was obtained which was excellent in the abrasion resistance, the light resistance, and the ozone resistance. However, the image forming property was not satisfactory. For example, slight intermingling of the ink droplets was observed on the PET sheet and on the art paper. Accordingly, the ink composition D is not suitable for forming a high-quality image.

As described above, according to the invention, an inkjet ink is provided which is excellent in the long-term storage stability, image quality, adhesion of the image to the recording medium, and suppression of bleed and intermingling of the ejected ink droplets. The invention also provides an image-forming method using the inkjet ink of the invention, the method achieving formation of a high-quality image with superior fixability to the recording medium.

What is claimed is:

1. An inkjet ink comprising a plurality of liquids, wherein:
at least one of the liquids constituting the inkjet ink includes a first reactive compound;
at least one of the liquids constituting the inkjet ink includes a second reactive compound;
any liquid including the first reactive compound does not include the second reactive compound;
the first reactive compound and the second reactive compound react with each other to form an aggregate or to increase viscosity of a mixture liquid containing the first and second reactive compounds;
at least one of the liquids constituting the inkjet ink includes a polymerizable compound;
at least one of the liquids constituting the inkjet ink includes a polymerization initiator; and
at least one of the liquids constituting the inkjet ink includes a colorant.

2. The inkjet ink according to claim 1, wherein any liquid including the polymerizable compound does not include the polymerization initiator.

3. The inkjet ink according to claim 1, wherein at least one liquid including the polymerizable compound includes the polymerization initiator.

4. The inkjet ink according to claim 1, wherein the first reactive compound and the second reactive compound are each in a liquid state at room temperature or soluble at room temperature in the polymerizable compound or the polymerization initiator if the polymerizable compound or the polymerization initiator is present in the same liquid.

5. The inkjet ink according to claim 1, wherein the colorant is a dye or a pigment.

6. The inkjet ink according to claim 1, wherein the first reactive compound reacts with the second reactive compound to form a hydrogen bond.

7. The inkjet ink according to claim 1, wherein the first reactive compound reacts with the second reactive compound to be crosslinked.

8. The inkjet ink according to claim 1, wherein the first reactive compound is a cation, and the second reactive compound is an anion.

9. The inkjet ink according to claim 1, wherein the inkjet ink comprises two liquids.

10. The inkjet ink according to claim 1, wherein the inkjet ink comprises at least three liquids.

11. The inkjet ink according to claim 1, wherein the liquids constituting the inkjet ink are water-insoluble.

12. The inkjet ink according to claim 1, wherein the first reactive compound is a compound having an acidic moiety and the second reactive compound is a compound having a basic moiety.

13. The inkjet ink according to claim 12, wherein the acidic moiety is selected from phenol groups, sulfonamide groups, substituted sulfonamide groups, carboxylic acid groups, sulfonic acid groups, or phosphoric acid groups.

14. The inkjet ink according to claim 12, wherein the compound having a basic moiety is selected from amine compounds, ammonium salts, hydrazine compounds, amidine compounds, guanidine compounds, or compounds each having a heterocycle containing a nitrogen atom.

15. An image-forming method comprising:
ejecting the inkjet ink of claim 1 onto a recording medium to form an image; and
applying energy to the formed image to cure the image.

16. The image-forming method according to claim 15, wherein the energy application is conducted by heating or irradiation with light.
